(19) United States
(12) Patent Application Publication
(10) Pub. No.: US 2020/0184659 A1
(43) Pub. Date: Jun. 11, 2020

(54) System and Method for Searching for Objects by Movement Trajectories on the Site Plan

(71) Applicant: OOO ITV Group, Moscow (RU)

(72) Inventors: Murat K. Altuev, Moscow (RU); Nikita .S Skiba, Nalchik (RU)

(21) Appl. No.: 16/574,113

(22) Filed: Sep. 18, 2019

(30) Foreign Application Priority Data
Dec. 6, 2018 (RU) 2018143321

(51) Int. Cl. G06T 7/292; G06T 17/10; G06K 9/62; G06K 9/00; H04N 7/18

(52) U.S. Cl. CPC G06T 7/292; G06T 17/10; G06K 9/6215; G06T 2207/10016; H04N 7/181; G06T 2207/30241; G06K 9/00268

(57) ABSTRACT

The system for display the movement of objects in the controlled area comprise multiple sensors or devices, memory, image display unit, graphical user interface, data input/output device, and data processing device. The data processing device is configured to receive a request, as well as the search criteria from the user to perform the search for the object data. Drawing and display of the object movement scheme in the site plan using the data obtained from the various sensors and/or devices that determine specific position of the object at specific points of time is achieved.

### RELATED APPLICATIONS

This application claims priority to Russian Patent Application No. RU 2018143321, filed Dec. 6, 2018, which is incorporated herein by reference in its entirety.

### FIELD OF THE INVENTION

The invention refers to the field of search and surveillance systems and namely to technologies aimed at searching for the objects using graphical primitives set on the site plan

### BACKGROUND

Surveillance systems are most often applied for security and control of premises or areas. Typically, these systems use video cameras to identify and track the movement of objects within the protected area. For example, video cameras can be used to detect unauthorized access by people or vehicles. In addition, video data obtained from surveillance cameras can be used to identify/recognize and locate specific persons whose activities are of interest to the operator for any reason. In addition to video cameras, these systems also use devices for receiving/collecting data applied for further analysis to identify information on objects of interest. Such devices may include, for example, access control and management systems (ACS), tag readers, sensors that transmit the objects position (trackers, bracelets), and so on.

In order to analyze, process, and compare the data received from multiple different data-capture devices, the surveillance system should have quiet high computing capabilities. Thus, there are many technologies in the background of the invention applied for improving the accuracy of search for the objects such as specifying certain search characteristics describing either the object of interest or the time and place of the event of interest.

In addition, in the background of the invention there is a solution disclosed in RU 2017131075 A1, publ. 9 Apr. 2017, characterizing the system and methods for detection of alarming object trajectories. This solution is based on classification of the object movement trajectories according to preset rules. In this case, the mentioned rules in particular are associated with the set graphic primitives which are referred to as surfaces in the context of this solution.

In addition, in the background of the invention there is a solution disclosed in RU 2018104556-ê1, publ. 2 Jun. 2018, characterizing the system and methods for detection of alarming object trajectories. This solution discloses the system containing, among other elements, a graphical user interface designed with the possibility of processing the object metadata and containing: block for assignment of graphical primitives, block for assignment of object movement trajectories classification rules, as well as the classification block designed with the possibility of checking each movement trajectory according to the rules, specified in the classification rules assignment block, for revealing the alarming object movement trajectories. In comparison with the claim RU 2017131075 A1, this solution provides a possibility to set more complex graphic primitives and, hence, more complex classification rules.

The basic difference between the known solutions and the claimed one is lack of possibility to search for specific objects of interest on the site plane according to all objects movement trajectories available in the system. The known solutions are aimed at global tracing of violations occurring in the protected territory. Thus, they are not directly related to the search for specific objects.

Thus, the claimed solution is the enhancement of the known solutions described above and features the possibility to assign similar graphic primitives, whereby the primitives are set on the site plan and used for search for the objects by their movement trajectories on the mentioned site plan.

Also, in the background of the solution, there is a solution disclosed in CA 2545535 C1, publ. 26 Jan. 2016, in which the graphical user interface of the video surveillance system allows the user to set the video “stretch” and some characteristics to classify the object movement trajectories. However, this solution is narrowly focused only on video data processing and does not imply processing the data stream received from multiple different data-capture devices.

In addition, in the background of the solution, there is a solution disclosed in U.S. Pat. No. 9,727,976 B1, publ. 8 Aug. 2017, which characterizes the computing device and the method used to search for objects upon request. This solution features execution of stages that include: construction of a geo-space time-semantic (GTS) chart, which contains nodes that represent the objects, whereby each node corresponds to the object movement trajectory over time, and the edges that connect the corresponding pairs of nodes; providing the GTS chart to the search engine to perform the search upon request. This invention though allows receiving the objects movement trajectories based on the data from various data-capture devices and to carry out the search by the set criteria; however, this solution offers no possibility to set the graphic primitives and, hence, apply them at the search.

### BRIEF SUMMARY

This claimed technical solution is aimed to eliminate the disadvantages of the previous background of the invention and develop the existing solutions.

The technical result of the claimed group of inventions consists in improving the accuracy of search for the objects by their trajectories on the site plan by using preset graphic primitives on the site plan and specific search characteristics.

This technical result is achieved by the fact that the computer system for searching the objects by their trajectories on the site plan includes the following: at least one data processing device; multiple different data-capture devices capable to collect and provide data, including object metadata, whereby the metadata includes at least a set of object positions at different points of time; memory capable to store the data obtained from multiple data-capture devices; graphical user interface containing data input and output tools, whereby the data input tools include: block of graphical primitives, with the ability to specify at least one graphical primitive on the site plan by selecting multiple points on the plan coordinate system; search characteristic assignment block capable to set parameters of objects for search and select the search type taking into account set graphical primitives; search block capable to search for the objects by their trajectories drawn by the data processing device on the site plan for each object based on the data received from multiple data-capture devices at different times, whereby the search is performed taking into account the set search characteristics and graphical primitives; whereby the data output tools include a display block capable to display the search results.

This technical result is also achieved by the method for searching for the objects by their trajectories on the site plan which is implemented by a computer system and contains the stages at which: data that includes object metadata is collected and provided to the user, whereby metadata includes at least a set of object positions at certain points of time, whereby the data is stored in memory; at least one graphical primitive is set on the site by selecting multiple points in the site plan coordinate system; search characteristics are defined by setting parameters of the objects for search and selection of the search type taking into account the specified graphical primitives; the search for the objects by their movement trajectories drawn by the data processing device on the site plan for each object based on the data obtained from multiple of different data-capture devices at different points of time is carried out, whereby the search is carried out taking into account the specified search characteristics and the graphical primitives; search results are displayed on the display device.

In one particular version of the claimed solutions, the search object parameters include at least the following parameters: movement direction, type, color, identifier (ID), minimum allowed speed, maximum allowed speed, minimum allowed size, maximum allowed size.

In another particular version of the claimed solutions, the search types include at least the following options: search by faces, search by vehicle registration numbers, search by identifiers in the Access Control System (ACS).

In another particular version of the claimed solutions, the search types include at least the following options: movement in a certain area; simultaneous stay of multiple objects in a certain area; long stay of the object in a certain area; transition from one area to another; intersection of at least one set graphic primitive.

In one more particular version of the claimed solutions, the search results can be presented as one of the following: a set of video records showing the corresponding characteristics of the search for object movement trajectories on the site plan; a set of photos of the detected objects; a list of identifiers of the detected objects.

In another particular version of the claimed solutions, data-capture devices are stationary, mobile, or a combination of these two types.

In one more particular version of the claimed solutions, in case when the data-capture device is stationary, for construction of the object movement trajectories, the data processing device is in addition configured and supplemented with possibility to set position of each such stationary data-capture device on the site plan.

In another particular version of the claimed solutions, in case when the data-capture device is mobile, for construction of object movement trajectories, the data processing device is additionally configured and supplemented with possibility to transform the object position coordinates received from mobile data-capture devices automatically from initial coordinate system into coordinate system of the site plan.

In another particular version of the claimed solutions, in the case when the data-capture device is a video camera and contains computer vision tools for video analysis, the system data processing device is additionally configured to perform the following functions: transfer of the object position coordinates from the frame coordinate system into the site plan coordinate system; thus, all cameras are linked to the site plan; and matching the object data obtained from different cameras to create a single movement trajectory for each object on the site plan.

In another particular version of the claimed solutions, when comparing the object data from different cameras, at least one criterion or a combination of the following criteria is applied: temporal proximity of the detected objects between the adjacent cameras; extrapolation of the future object position when it leaves the field of view of one camera and the proximity of this extrapolation to the observed positions of objects in the field of view of the other cameras; visual similarity of objects both in terms of external features and recognition of faces of vehicle registration numbers.

In another particular version of the claimed solutions, the site plan is a geographic information system (GIS) or an image, whereby in the case when the site plan is an image, a graphical user interface is additionally configured to enable the system operator comparing the obtained coordinates of the static object positions with their specific locations on the site plan.

This technical result is also achieved through a computer-readable data carrier that contains instructions performed by the computer for implementing the method options for search for the objects by their trajectories on the site plan.

### BRIEF DESCRIPTION OF THE SEVERAL VIEWS OF THE DRAWINGS

FIG. 1—block diagram of the computer system for searching for objects by their trajectories on the site plan.

FIG. 2—example of searching for objects by object movement trajectories on the office plan.

FIG. 3—block diagram of one of the implementation options for search for the objects by their trajectories on the site plan.

### DETAILED DESCRIPTION

Description of the approximate embodiments of the claimed group of inventions is presented below. However, the claimed group of inventions is not limited only to these embodiments. It will be obvious to persons who are experienced in this field that other embodiments may fall within the scope of the claimed group of inventions described in the claim.

The technical solution in its various implementation options can be implemented in the form of computer systems and methods for searching for objects by their trajectories on the site plan, as well as in the form of a computer-readable data carrier.

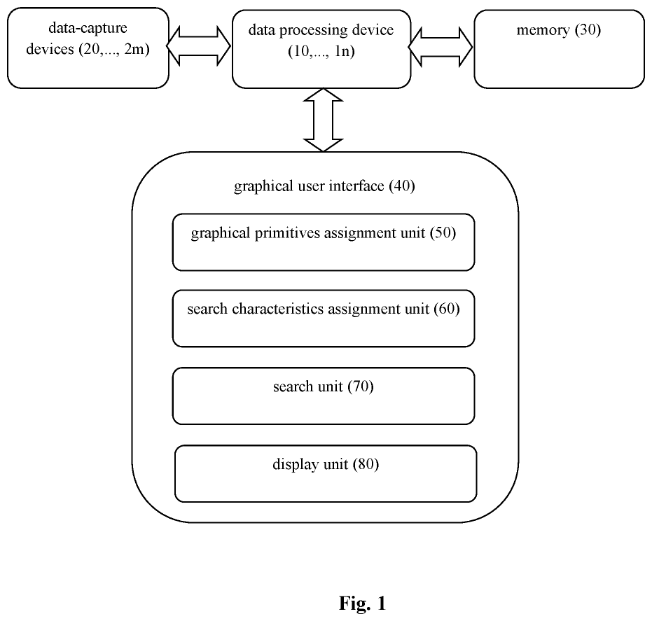

FIG. 1 shows a block diagram of one of the implementation options for search for the objects by their trajectories on the site plan. In its basic configuration, the system includes the following: at least one data processing device (10, . . . , 1n), multiple different data-capture devices (20, . . . , 2m); memory (30); and graphical user interface (40) which contains the following: a unit for assignment of graphical primitives (50), a unit for assignment of search characteristics (60), a unit for search characteristics (70), and a display unit (80). The specified units (50), (60) and (70) of the user interface are the data input tools, while the unit (80) of the user interface is the data output tool.

In this context, computer systems may be any hardware- and software-based computer systems, such as personal computers, smartphones, laptops, tablets, etc.

The data processing device in different design options can be arranged as: processor, microprocessor, computer, PLC (programmable logic controller), or integrated circuit.

Memory devices may include, but are not limited to, hard disk drives (HDDs), flash memory, ROMs (read-only memory), solid state drives (SSDs), etc.

Data capture devices are any computing devices that can collect and provide data, including object metadata. The data-capture device can be one of the following devices: video camera, GPS sensor, GLONASS sensor, object detector. In some execution options, the data-capture device may be a security bracelet that provides GPS or GLONASS coordinates. Thus, it is necessary to understand that the mentioned data-capture devices can be either stationary or mobile.

The graphical user interface (GUI) is a system of tools for user interaction with the computer system based on representation of all system objects and functions available to the user in the form of graphical screen components (windows, icons, menus, buttons, lists, etc.). Thus, the user has random access (through data input devices) to all visible screen objects—interface blocks—which are displayed on the screen (monitor).

It should be noted that the specified system can include any other devices known in the background of the invention. For example, data input devices that are, but are not limited to, mouse, keyboard, touchpad, stylus, joystick, trackpad, etc.

A specific example of how the above-mentioned computer system of search for the objects by their movement trajectories on the site plan is described below.

Multiple data-capture devices receive a stream of data to make the computer system work. This data stream contains metadata of objects and the metadata includes at least a set of positions (coordinates) of objects at different points of time. The data stream may be a video stream if the data-capture device is a video camera, or a metadata stream of objects if the data-capture device is, for example, a sensor or an object detector. The computer system memory is configured to store all data from multiple different data-capture devices at different points of time.

In addition, the system memory stores the site plan. In order to further understand the nature of the proposed solution, it is necessary to clarify that the site plan is a kind of a topographic map or a drawing (picture) of a small area in a given scale. The site plan is either an image in a public available format or data from the geographic information system (GIS), such as an Open Street Map.

Thus, if the site plan is an image, instead of a geo-map, the system operator compares static object position coordinates received from the data-capture devices with their specific locations on the site plan by means of the graphical user interface tools. As static (stationary) objects can be various pieces of furniture, office and/or household appliances, doors, window sills, corners of walls, and other items having a three-dimensional structure. This comparison/binding is required for further conversion of coordinates of the moving objects from the original coordinate system of the data-capture device to the site plan coordinate system which is performed by the data processing device automatically.

The resulting data stream is then sent to the graphical user interface as well as the data processing devices. Based on the received data, at least one data processing device draws the movement trajectory for each object on the site plan.

Thus, for each stationary data-capture device (i.e., the device which records the object position at a particular point), the data processing device is configured with the option to specify the position of each such stationary data-capture device on the site plan (link it to the site plan) when constructing the object trajectory. The stationary data-capture devices mentioned above may include the devices such as ACSs, facial recognition devices, vehicle registration number recognition devices, video cameras, etc.

If the data-capture device is mobile (e.g. GPS/GLONASS trackers, bracelets, video recorders), the data processing device is additionally configured with the option to automatically convert the object position coordinates received from such mobile data-capture devices from the original coordinate system to the site plan coordinate system.

In the case when the data-capture device is a video camera containing computer vision tools for video analysis, the data processing device of the system is additionally configured for execution of the following options:

conversion of the object position coordinates from the frame coordinates system to the site plan coordinate system, with all video cameras linked to the site plan; and

comparison of the object data received from different cameras for drawing a single trajectory of each object on the site plan.

Thus, when comparing the object data from different cameras, i.e. when re-identifying the objects between the different cameras, at least one criterion or a combination of criteria is used to obtain a single trajectory of each identified object on the site plan:

temporal proximity of the fixed objects between the adjacent cameras;

extrapolation of the future position of the object when it leaves the field of view of one camera and proximity of this extrapolation to the observed positions of the objects in the field of view of other cameras;

visual similarity of the objects both in terms of appearance and recognition of faces of vehicle registration numbers.

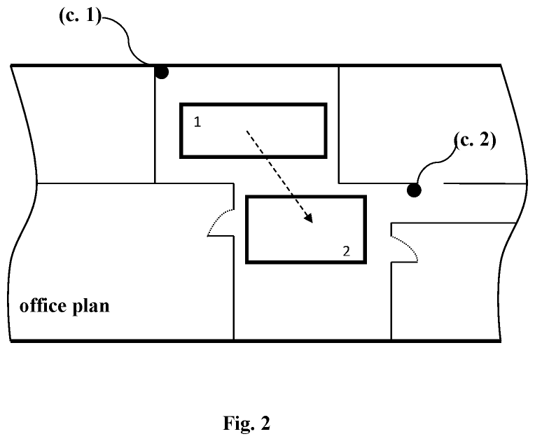

For example, FIG. 2 shows two video cameras (1 and 2) permanently installed in the guarded office. If, for example, the movement of the object is detected by the c.1, then disappears and is detected again in a couple of seconds by c. 2, the system can assume that the movement detected by these adjacent cameras is related to the same object (temporal proximity). However, the use of only one of these criteria for comparison is not a sufficiently precise way, so the criterion of visual similarity can be additionally applied enhance the accuracy level. Suppose, for example, there is a red object in the field of view of c. 1 and it moves in the direction to c. 2. If the red object appears in the field of view of c. 2 after a short time, it can be assumed with great certainty that it is the same object.

It is clear from the above that in various implementation options of the computer system, data-capture devices can be either stationary or mobile, or a combination of these two types. In this case, if a combination of these devices is used, the drawing of the object trajectory on the site plan will be a combination of the above methods for drawing applied by stationary and mobile data-capture devices.

To carry out the exact search for the required objects, the operator should set the graphic primitives in the graphic primitive assignment unit. In the context of this description, the graphic primitive is a virtual two-dimensional or three-dimensional surface, with the two-dimensional surface being at least one of the following: a segment, a straight line, a curve, a polygonal line, a polyline, an arc, etc., and the three-dimensional surface is at least one of the following: plane, polygonal surface, smoothly curved surface, multi-segment surface, etc.

In this block, the operator can specify one or more graphic primitives on the site plan by selecting several points in the coordinate system of this site plan. To do this, the operator can use the data input devices, for example, a computer mouse.

It should be mentioned that the operator can set several graphic primitives, that is a set which forms a so-called area of tracing inside of it. For example, the user can set four graphic primitives that form a rectangular tracking area. Thus, the operator is not limited in the arrangement of the mentioned graphic primitives in any way. That is, the primitives can be located randomly in relation to each other, or some rules set by the operator in options can be observed. For example, in some implementation options, the graphic primitives can be located in parallel. In other versions, the user can set a specific corner at which the graphic primitives will be located. For an example, FIG. 2 shows two rectangular areas of tracing (1 and 2) each of which is formed by four graphic primitives.

In the search characteristics unit, the operator can then specify certain parameters of the objects to be searched, as well as select the search type.

For further understanding of the claimed solution essence, it is necessary to explain that parameters of the search objects include at least the following parameters: movement direction, type, color, identifier (ID), minimum allowed speed, maximum allowed speed, minimum allowed size, maximum allowed size. Examples of the object types are: a person, a group of persons, or a vehicle. In addition, in order to increase the search accuracy, additional object parameters can be specified, such as the object gender or availability of the following object's items and features: bag, umbrella, hat, mustache, beard.

After setting the parameters of objects to be searched, the operator sets/selects one or several specific search types. Standard search types include at least the following: search by faces, search by vehicle registration numbers, search by identifiers in the access control system (ACS), etc.

It should be noted that the search types can be associated with the preset graphic primitives. These search types include at least the following: movement in a certain area; simultaneous stay of multiple objects in a certain area; long stay of the object in a certain area; transition from one area to another; intersection of at least one set graphic primitive.

Further, the system activates the search unit which is capable to search for the objects by their movement trajectories which have been drawn by the data processing device on the site plan for each object based on the data received from multiple data-capture devices at different points of time (which has already been described above in detail). It should be mentioned that search is carried out using all set search characteristics and graphic primitives.

FIG. 2 shows an example of searching for objects by their trajectories in the office plan. Two cameras (c.1 and c.2) are attached to the shown part of the office plan. The first camera's field of view covers the first tracking area, while the second camera's field of view covers the second tracking area. To perform the search, the data received in real time from the two specified cameras is used. The search type is set as transition (movement) of an object from area 1 to area 2.

After performing the search, the search results are displayed in the display unit.

The mentioned results can be presented, for example, as a set of photos of the objects detected or as a list of identifiers of the objects detected. In addition, the results can be presented in the form of a set of video records showing the corresponding characteristics of the search for the object movement trajectory on the site plan. To watch any video from the set, the operator should click on it to play it back.

Although functioning of the computer system has been described taking into account the fact that the data stream comes in real time and the search for objects is performed in real time respectively, sometimes it is necessary to perform the search for objects by archive data. For this case, the computer system memory is configured to record and store the archive of data received from multiple data-capture devices, and the computer system itself is additionally configured to search for objects by object movement trajectories received by the data processing data device from the archive data.

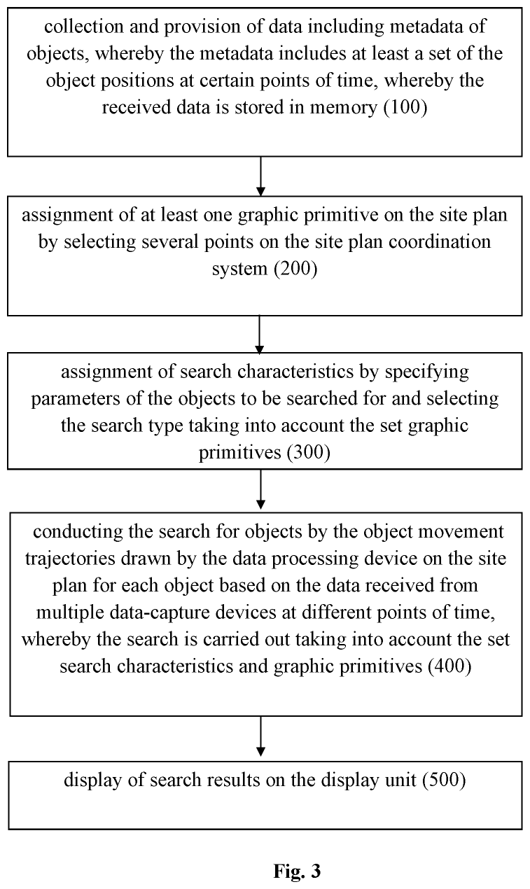

FIG. 3 shows a block diagram of one of the implementation options of the search for objects by their trajectories on the site plan. The specified method contains the stages at which:

Stage (100)—data including metadata of objects is collected and provided, whereby the metadata includes at least a set of the object positions at certain points of time, whereby the received data is stored in memory;

Stage (200)—at least one graphic primitive is set on the site plan by selecting several points in the site plan coordinate system;

Stage (300)—the search characteristics are defined by specifying parameters of the objects to be searched for and selecting the search type taking into account the set graphic primitives;

Stage (400)—search for objects by the object movement trajectories drawn by the data processing device on the site plan for each object based on the data received from multiple data-capture devices at different points of time is carried out, whereby the search is carried out taking into account the set search characteristics and graphic primitives;

Stage (500)—search results are displayed on the display device.

It should be mentioned that this method is performed (implemented) by a computer system and, therefore, can be expanded and refined by all particular versions that have been described above for computer system implementation.

Besides, the embodiment options of this group of inventions can be implemented with the use of software, hardware, software logic, or their combination. In this embodiment example, software logic, software, or a set of instructions are stored on one or multiple various conventional computer-readable data carriers.

In the context of this description, a “computer-readable data carrier” may be any environment or medium that can contain, store, transmit, distribute, or transport the instructions (commands) for their application (execution) by a computer device, such as a personal computer. A machine-readable carrier can be a non-volatile machine-readable carrier.

In one of the claimed solution implementation examples, a user interface scheme configured to provide at least some of the control functions described above can be suggested.

If necessary, at least some part of the various operations presented in the description of this solution can be performed in an order differing from the described one and/or simultaneously with each other.

Although the technical solution has been described in detail to illustrate the most currently required and preferred embodiments, it should be understood that the invention is not limited to the embodiments disclosed and, moreover, is intended to modify and combine various other features of the embodiments described. For example, it should be understood that this invention implies that, to the possible extent, one or more features of any embodiment option may be combined with one or more other features of any other embodiment option.

1. The system for searching for objects by trajectories on the site plan, comprising:
at least one data processing device;
multiple data-capture devices capable to collect and provide the data, including object metadata, whereby metadata include at least a set of object positions in different points of time;
memory featuring the option for saving the archive of data received from multiple data-capture devices;
graphical user interface comprising data input and output tools, whereby the above mentioned data input tools include:
graphical primitive assignment unit offering the ability to specify at least one graphical primitive on the site plan by selecting multiple points in the site plan coordinate system;
search feature assignment unit offering the ability to define the object parameters select the search type taking into account the set graphic primitives;
search unit offering the ability to search for objects by the object movement trajectories drawn by the data processing device on the site plan for each object based on the data received from multiple data-capture devices at different points of time, whereby the search is carried out taking into account the set search characteristics and graphic primitives;
the mentioned output tools contain a display unit which is capable to display the search results.

2. The system of claim 1, wherein the parameters of the objects for search include at least the following parameters:
movement direction;
type;
color;
identifier (ID);
minimum allowed speed;
maximum allowed speed;
minimum allowed size;
maximum allowed size.

3. The system of claim 2, wherein the search types include at least the following types:
search by faces;
search by vehicle registration numbers;
search by identifiers in the access control system (ACS).

4. The system of claim 2, wherein the search types include at least the following types:
movement in a certain zone;
simultaneous stay of multiple objects in a certain zone;
long stay of an object in a certain zone;
transition from one zone to another;
intersection of a certain zone by at least one graphical primitive.

5. The system of claim 1, wherein the search results can be presented as one of the following options:
a set of videos showing the corresponding features of search for objects trajectories on the site plan.
a set of photos of the detected objects;
a list of identifiers of the detected objects.

6. The system of claim 5, wherein the data-capture devices are stationary, mobile, or a combination of these types.

7. The system of claim 6, wherein the case when the data-capture device is stationary, the data processing device for drawing the object trajectories is additionally configured with the option to set the location of each stationary data-capture device on the site plan.

8. The system of claim 6, wherein the case when the data-capture device is mobile, the data processing device for drawing the object trajectories is additionally configured with the option to automatically convert the object location coordinates received from mobile data-capture devices from the source coordinate system to the coordinate system of the site plan.

9. The system of claim 6, wherein the data-capture device is a video camera containing computer vision tools for video analysis, the data processing device of the system is additionally configured for execution of the following options:
conversion of the object position coordinates from the frame coordinates system to the site plan coordinate system, with all video cameras linked to the site plan; and
comparison of the object data received from different cameras for drawing a single trajectory of each object on the site plan.

10. The system of claim 9, wherein when comparing the object data from different cameras, at least one or a combination of the following criteria is used:
temporal proximity of the fixed objects between the adjacent cameras;
extrapolation of the future position of the object when it leaves the field of view of one camera and proximity of this extrapolation to the observed positions of the objects in the field of view of other cameras;
visual similarity of the objects both in terms of appearance and recognition of faces of vehicle registration numbers.

11. The system of claim 10, wherein the site plan is a geo-information system (GIS) or an image,
whereby in the case when the site plan is an image, a graphical user interface is additionally configured to enable the system operator comparing the obtained coordinates of the static object positions with their specific locations on the site plan.

12. The method for searching for objects by their trajectories on the site plan implemented by a computer system and comprising the stages at which:
data including metadata of objects is collected and provided, whereby the metadata includes at least a set of the object positions at certain points of time, whereby the received data is stored in memory;
at least one graphic primitive is set on the site plan by selecting several points in the site plan coordinate system;
the search characteristics are defined by specifying parameters of the objects to be searched for and selecting the search type taking into account the set graphic primitives;
the search for objects by the object movement trajectories drawn by the data processing device on the site plan for each object based on the data received from multiple data-capture devices at different points of time is carried out, whereby the search is carried out taking into account the set search characteristics and graphic primitives;
search results are displayed on the display device.

13. The method of claim 12, wherein the parameters of the objects for search include at least the following parameters:
movement direction;
type;
color;
identifier (ID);
minimum allowed speed;
maximum allowed speed;
minimum allowed size;
maximum allowed size.

14. The method of claim 13, wherein the search types include at least the following types:
search by faces;
search by vehicle registration numbers;
search by identifiers in the access control system (ACS).

15. The method of claim 13, wherein the search types include at least the following types:
movement in a certain zone;
simultaneous stay of multiple objects in a certain zone;
long stay of an object in a certain zone;
transition from one zone to another;
intersection of a certain zone by at least one graphical primitive.

16. The method of claim 12, wherein the search results can be presented as one of the following options:
a set of videos showing the corresponding features of search for objects trajectories on the site plan;
a set of photos of the detected objects;
a list of identifiers of the detected objects.

17. The method of claim 16, wherein the data-capture devices are stationary, mobile, or a combination of these types.

18. The method of claim 17, wherein the case when the data-capture device is stationary, the data processing device for drawing the object trajectories is additionally configured with the option to set the location of each stationary data-capture device on the site plan.

19. The method of claim 17, wherein the case when the data-capture device is mobile, the data processing device for drawing the object trajectories is additionally configured with the option to automatically convert the object location coordinates received from mobile data-capture devices from the source coordinate system to the coordinate system of the site plan.

20. The method of claim 17, wherein the data-capture device is a video camera comprising computer vision tools for video analysis, the data processing device of the system is additionally configured for execution of the following options:
conversion of the object position coordinates from the frame coordinates system to the site plan coordinate system, with all video cameras linked to the site plan; and
comparison of the object data received from different cameras for drawing a single trajectory of each object on the site plan.

21. The method of claim 20, wherein when comparing the object data from different cameras, at least one or a combination of the following criteria is used:
temporal proximity of the fixed objects between the adjacent cameras;
extrapolation of the future position of the object when it leaves the field of view of one camera and proximity of this extrapolation to the observed positions of the objects in the field of view of other cameras;
visual similarity of the objects both in terms of appearance and recognition of faces of vehicle registration numbers.

22. The method of claim 21 wherein the site plan is a geo-information system (GIS) or an image,
whereby in the case when the site plan is an image, a graphical user interface is additionally configured to enable the system operator comparing the obtained coordinates of the static object positions with their specific locations on the site plan.

23. Non-transitory computer readable medium storing instructions that, when executed by a computer, cause it to perform the method of claim 12.
